(19) United States
(12) Patent Application Publication
(10) Pub. No.: US 2006/0102582 A1
(43) Pub. Date: May 18, 2006

(54) Thermochromic inserts for cups

(76) Inventors: Paul C. Wakefield, Lawrenceburg, IN (US); Charlene A. Massing, Lawrenceburg, IN (US)

Correspondence Address: William M. Selenke, 5 Drummond St., Cincinnati, OH, 45218, US

(21) Appl. No.: 10/992,041

(22) Filed: Nov. 18, 2004

(51) Int. Cl. A47J 41/02

(52) U.S. Cl. 215/12.1

(57) ABSTRACT

The invention is an improved truncated cone-shaped thermochromic insert for cups which insert has applications of thermochromic materials. The spindle used to form the inserts is about 1/64 inch larger than the outside wall of the inner core of the cup. The insert is made by mating a first end of a insert with to a second end of that insert. That insert is in direct physical contact with the outside wall of the inner core of cup. That direct contact is achieved by is forced contact to produce a friction fit between truncated cone insert and the outer wall of the inner container. In addition, direct contact between the insert and the outside wall of the inner core of said cup is achieved by adhesives or a lower extension of insert extending beyond the bottom the inner container thereby causing a forced fit. Direct contact between the dehydrated insert and the outside wall of the inner core of the cup is maintained by adhesives. The invention includes a method for making cups with thermochromic inserts with the steps of urging onto outer surface of the inner core of the cup the truncated cone shaped inserts, so the truncated cone shaped insert is in direct contact with the outer surface of inner cup.

### FIELD OF INVENTION

The invention is concerned with flexible inserts with thermochromic inks that are placed in the insulating space of hot or cold drink cups or tumblers. More specifically the invention is concerned with the proper configuration and placement of the inserts so that the color changes are more rapid and more nearly uniform. Simply placing a printed paper or other flexible material with the thermochromic inks within the insulated space of a cup or tumblers has limited usefulness.

### BACKGROUND OF INVENTION

Within the past decade or so, various insulated cups or tumblers, many of them with advertising inserts, have become quite popular. Many of these cups have the advertising indices embossed or printed on the outside. Other common techniques to personalize these cups are printed paper inserts or other flexible writing surfaces that fit in the insulating space between the two walls of the cup. This second means the personalizing cups is quite useful in that a limited number of cups can be made inexpensively. A stock cup and customized inserts may be used to produce inexpensively a limited number of cups with thermochromic inserts.

A further advantage of the present invention involves the use of thermochromic inks of various types. Thermochromic inks are well known to the industry. They are available in almost unlimited colors and are activated to become either visible or invisible at various temperatures. Thus a designer who wishes a specific color change at a specific temperature can usually obtain the desired thermochromic ink to produce the desired effect.

The availability of various thermochromic materials is well known to the art and commerce. A well-known international supplier of these photochromic and thermochromic materials is Matsui Corporation of Japan.

The present invention does not limit itself to covering a printed insert with thermochromic materials. The printing ink or material could be of thermochromic materials. In other cases there may be a partial revealing of the underlining printed materials with one kind of thermochromic materials. A second kind of thermochromic materials may reveal a second illustration under different environmental conditions. The present invention is concerned with the used of various thermochromic and photochromic materials to reveal or conceal underlying illustration. These underlying materials may in turn consist of regular inks or thermochromic materials. Common to the art of printing of is the use of a four-color system. The inserts of the present invention may be printed by any of the various techniques of printing.

In is common to the art that the inner container of insulating cups is manufactured of dark material and the outer cover is manufactured with clear or transparent material. However, the present invention allows for the inner container to be clear and the outer container to be darker or both the inner container and outer container to be clear.

Likewise, the present invention is not concerned with specific thermochromic materials. Companies such as the Matsui Corp. produce a wide array of thermochromic materials. Thus by consulting Matsui catalog the printers can determine which materials respond to the expected environmental changes. Typically, of course, the changes in the temperature of the liquid beverage will change the transparency of the thermochromic materials. If heat is applied the opacity of the thermochromic materials will change from opaque to clear. However, the opposite may be produced in that is the thermochromic material can be opaque at high temperature and clear at a lower temperature. Likewise, the present invention teaches that the thermochromic materials may be responsive to infrared or ultraviolet (black) light. That is, if a beverage vessel were placed in the ultraviolet light of sunshine, the beverage cup could be used as an indication of how much ambient ultraviolet light is present and therefore how much ultra violet light exposure the people around the cup are receiving.

More specifically the following inks and microcapsules have been used in this invention to product the following results. Matsui Corporation, as do other suppliers, supply thermochromic materials in slurry, which comprises an aqueous base with microcapsules coupled with latex or other binders. Likewise, the slurry may have a surfactant and a dispersion agent. A typical formulation would have about 70% Matsui slurry, 25% Carrier B (binder/carrier, or carrier/binder) from Sun Chemical Corp. (or commercial equivalent carriers) and about 5% drying inhibitor from Matsui. This slurry can be applied to inserts by various printing techniques. However, the preferred method is silk screening through 160-200 mesh silk screen with emulsions suitable for aqueous inks. Optionally to acquire a more nearly uniform coat of thermochromic materials, the slurry may be applied twice or more often. A further option for thermochromic slurries that are applied to products that are exposed to sunlight is to add a UV inhibitor such as Ciba-Geigy 5150 to the slurry.

A further advantage of the present invention is that it can be used to produce a customized memento. Digital cameras, computers, scanners, and color printers are widely used in the United States. One can take a picture with a digital camera, transfer the data to the computer, and print that color picture by itself or as a part of an image template. Or a producer can also take a standard printed picture, scan the picture, and transfer the image into the computer and print that color image by itself or as a part of an image template. For the present invention, pictures are printed on the truncated cone-shaped inserts.

After printing on the insert paper, the picture can be covered with the thermochromic or photochromic materials and placed in the insulation space between the inner container and the outer cover to produce a personalized memento.

Experimentation and development indicated certain deficiencies in the current art. These deficiencies were overcome with following three improvements. The first these improvements is that the insert must be in direct contact with the inner core of the cup. This can be done several ways. One way is to simply use adhesives to affix the flat insert to the inner core of the cup. These adhesives may either be on the inner core or on the inner surface of the cone insert. A second way is to attach one end of the insert with the other end to make a truncated cone. The can be done with tabs and slots, glue, or tape. Gentle pressure assures that the truncated cone with the thermochromic indices will be in direct contact with the inner surface. A further improvement is to make the truncated cone insert is long enough so that as it is placed in the insulating space the thermochromic insert is urged to stay in direct contact with the inner surface. It is also useful to use a metal or stainless steel inner core which aids in the transfer of heat.

It is to be noted that the microcapsules containing thermochromic inks are in aqueous suspension. It is discovered experimentally that the color change of the thermochromic inks is more rapid if there is minimal moisture in the inner space. Drying to less than 10% humidity, and preferably 6 to 8% humidity after printing improves the rate and uniformity of the color change. Humidity is removed with standard dehydrating devices using heat and vacuum. Likewise it is to be noted that inserts damp from the application of aqueous thermo chromic inks will shrink as they are dried. For this reason, the cone spindle used to print the cups is about 1/64 inch larger in diameter then the outer wall of the inner cup.

It is to be noted that the present invention is concerned with the full spectrum of inks that change with environmental conditions. Included in the teaching of the present invention are thermochromic or photochromic inks that are affected by cold or are florescent in the dark. Thermochromic inks that become clear at temperatures near the melting point of ice are a useful novelty in bars and lounges especially “Gentlemen's Clubs” wherein showgirl figures become visible with cold produced by an iced drink in the advertising cup.

### BRIEF DESCRIPTION OF THE FIGURES

FIGS. 1, 2 and 3 show the current art.

FIG. 1 shows an exploded view of the insulated vessel.

FIG. 2 shows the vessel in assembled form.

FIG. 3 shows the isolated inserts.

FIG. 4 shows means to assure contact between the coup core and the insert.

FIG. 5 shows the outline of the assembly process.

FIG. 6 is an illustration of cut AA of FIG. 2.

### DETAILED DESCRIPTION OF THE FIGURES

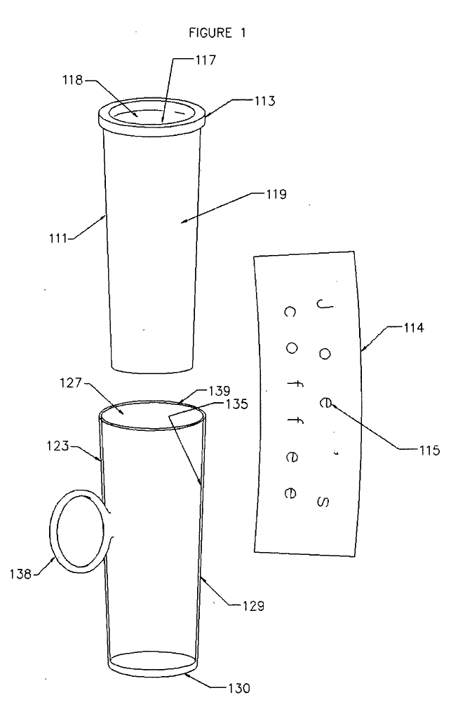

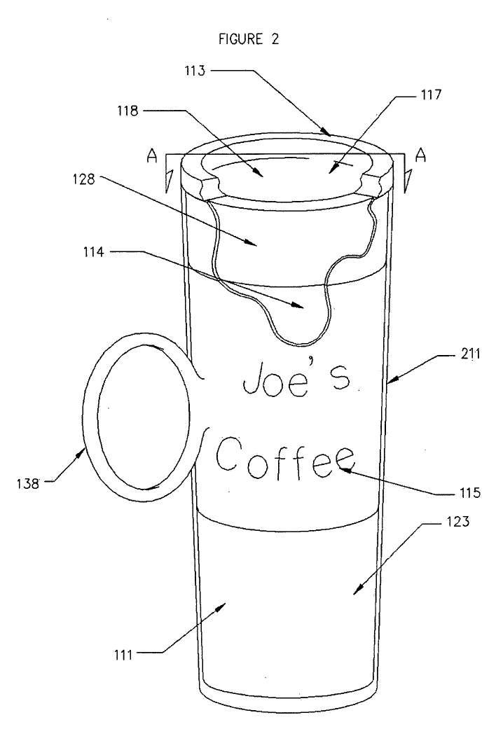

FIG. 1 shows outer container 123 of cup (vessel) 211. Inner container 111 may be made of any one of various plastics. However, stainless steel is a good conductor of heat and the inner container 111 may be fabricated of stainless steel or other such metals. Inner container 111 has a ring collar 113, which surrounds the opening 118 that leads to the beverage volume 117 of the cup 211. Inner container 111 has an outer wall 119. Outer cover 123, which is usually transparent, has the upper opening 127. The outer wall 129 of outer cover 123 provides a tapered cylindrical shape, which ends in a closed base 130. A printed insert 114, which is cut so that when it is rolled, will produce a paper cylindrical shape. The printed insert 114 has in this case the printing, “Joe's Coffee,” 115. This printing is covered with a layer of thermochromic materials so that when the temperature changes the writing “Joe's Coffee” is either revealed or concealed. Insert 114 is rolled into a tapered cylindrical form and placed along the inner wall 135 of cup outer cover 123. An optional handle 138 is permanently affixed to the cup. Handle 138 is attached to the outer surface 129 of the outer cover 123 as part of the process of injection molding. Insert 114 is placed in the outer cover 123. Inner container 111 is placed through opening 127 into the inner space of the outer container 123. Collar 113 is affixed and sealed on upper lips 139 of the outer container 123. The means of affixing can be adhesives, sonic welding, spin welding, or threads. The assembled cup is shown as FIG. 2.

FIG. 2 shows the assembled beverage vessel 211 of the present invention. Cup 211 is made when outer container 123 with upper lip 139 is affixed to ring collar 113. Outer container 123 and inner container 111 now enclose insert 114 with printed information 115. Handle 138 is attached to outer cover 123. Inner container 111 is shown in part. Opening 118 leads to the beverage volume 117 of the vessel 211. A cut out 128 reveals the inner construction of the beverage vessel 211.

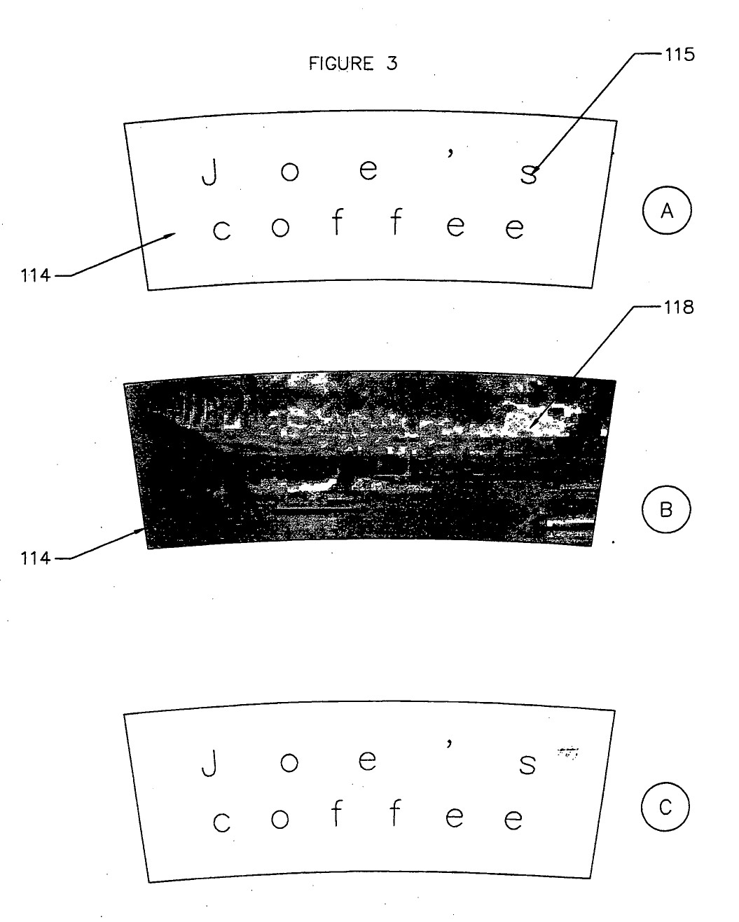

FIG. 3 shows the production of the insert 114. Insert 114 is cut such that when it is rolled it fits into the inner space between inner container 111 and outer cover 123. Using standard printing techniques illustration or information 115 (in this case “Joe's coffee”), is applied on the insert A. FIG. 3 B shows insert 114 after receiving the silk screen printing of the thermochromic slurry. This indicates that any illustration 115 is rendered hidden by opaque thermochromic materials 118. In this example, thermochromic materials 118 provides a second scene which conceals illustration 115, “Joes Coffee.” FIG. 3 C shows the insert after environmental changes such as temperature or UV light clarifies the opaque slurry (thermochromic materials 118) to reveal the illustration 114, “Joe's coffee.”

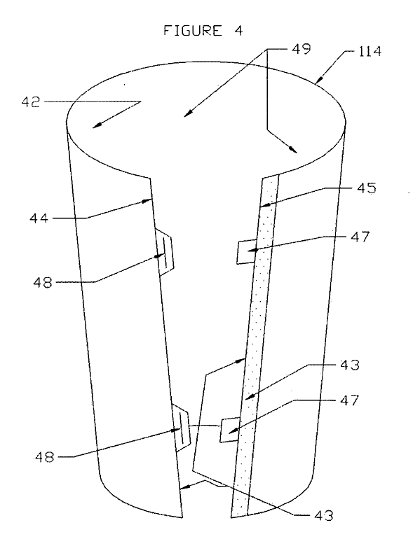

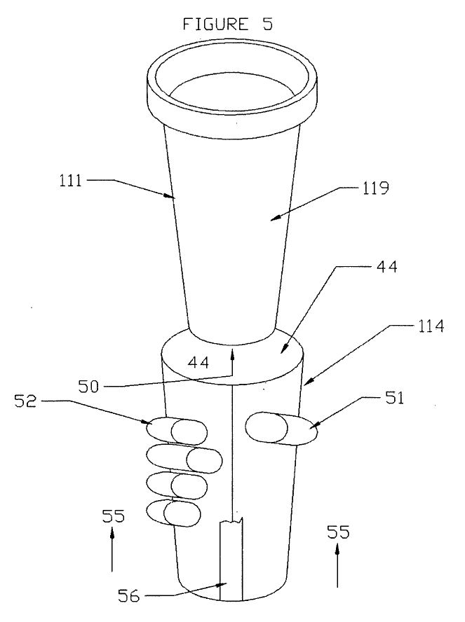

Various means of creating a truncated cone shaped insert are shown in FIG. 4. To assure optimal change of the thermochromic or photochromic inks of the insert the insert must be in direct physical contact with the outside wall of the inner core. Any air between the core and the insert would inhibit the color change of the inks. Insert 114 is shown in a partially rolled position. The inner surface 42 of the insert 114 may be covered with contact adhesive 49. Contact adhesive 49 will assure contact between the insert 114 and the outer wall 119 of the inner container 111. Likewise, a line of secondary adhesive 43 would allow all of the mating of the first end 44 with the second end 45 of the insert 114. A third means of assuring physical contact with the outer wall 119 of the inner container 111 is the use of tabs 47 which will mate the second end 45 with the first end 44 which has slots 48 to accept the male tab 47. Adhesives other than contact adhesives may be places on the inner surface 42 of the insert 114, or on the outer surface of the outer wall 119. An alternative means of mating of the first end 44 with the second end 45 of the insert 114 is with tape 56 as show in FIG. 5.

FIG. 5 illustrated the placement of the insert 114 over the outer wall 119 of the inner container 111. A hand with a thumb 51 and fingers 52 grasps the truncated cone insert 114 and the truncated cone insert is forced as indicated by arrows 55 so that truncated cone insert 114 will fit snug over the outer wall 119 of the inner container 111.

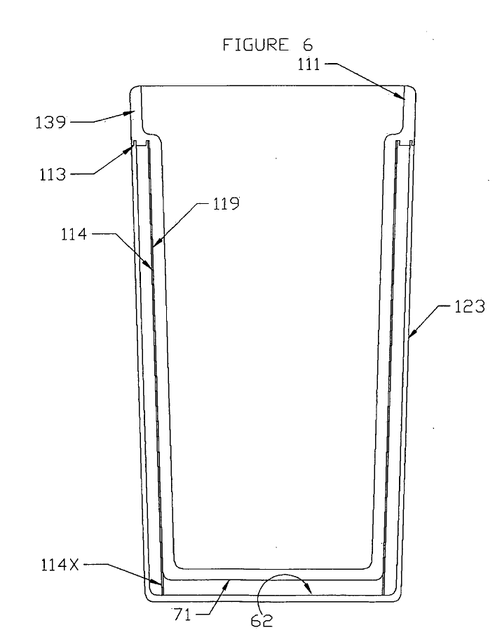

FIG. 6 shows a vertical slice A-A as shown in FIG. 2. The insert 114 is in physical contact with the outer wall 119 of the inner container 111. A lower extension of insert 114, 114×extends beyond the bottom 71 the inner container 111. Extension 114X urges the truncated cone insert 114 to maintain close contact with the outer wall 119 of the inner container 111. Outer cover 123, which is usually transparent, mates with inner container 111.

Lower extension 114X urges the truncated cone 114 insert to maintain close contact with the outer wall 119 of the inner container 111 by transferring pressure from the inside base 62 of outer container 123 to the outer wall 119 of inner container 111.

Summery of Invention

The invention is an improved thermochromic insert for cups which insert has applications of thermochromic materials truncated to a truncated cone-shaped insert. The insert is dehydrated to less than 10% humidity and preferably 6-8% humidity. The spindle used to form said inserts is about 1/64 inch larger than said outside wall of the inner core of said cup.

The first end of said insert is mated to said second end of said insert by a line of secondary adhesive, by tabs and slots, or by tape. The truncated cone-shaped insert with applications of thermochromic materials is dehydrated prior to placement direct on the inner core of the cup.

Direct contact between the insert and the outside wall of the inner core of the cup is maintained by adhesives on inner surface of said insert or on the outside wall of the inner core of the cup. Likewise, direct contact between the insert and the outside wall of the inner core of said cup is achieved by is forced contact to produce a friction fit between truncated cone insert and the outer wall of the inner container. In addition, direct contact between the insert and the outside wall of the inner core of said cup is achieved by a lower extension of insert extending beyond the bottom the inner container thereby causing a forced fit. The inner core of the cup can be made of plastic or stainless steel and the thermo chromic materials may be chosen so that the illustration is revealed beverage is cooled to near the temperature of an iced drink. The insert is made by mating a first end of a insert with to a second end of that insert. That insert is in direct physical contact with the outside wall of the inner core of said cup. The invention includes a method for making cups with thermochromic inserts with the steps of urging onto outer surface of the inner core of the cup the truncated cone shaped inserts, so said truncated cone shaped insert is in direct contact with said outer surface. The inserts have applied thermochromic materials; and are within the outer container. The collar of the inner container is attached to the upper lip of the outer container by means of adhesives, sonic welding, spin welding, or threads.

We claim:

1) An improved thermochromic insert for cups comprising:
applications of thermochromic materials on a truncated cone-shaped insert;
said insert is made by mating a first end of said insert with to a second end of said insert;
said insert is placed in direct physical contact with the outside wall of the inner core of a cup.

2) An improved thermochromic insert for cups as in claim 1) wherein said first end of said insert is mated to said second end of said insert is by a line of secondary adhesive.

3) An improved thermochromic insert for cups as in claim 1) wherein said first end of said insert is mated to said second end of said insert is by tabs and slots.

4) An improved thermochromic insert for cups as in claim 1) wherein said first end of said insert is mated to said second end of said insert is by tape.

5) An improved thermochromic insert for cups as in claim 1) wherein said applications of thermochromic materials on truncated cone-shaped insert is dehydrated prior to placement in the cup.

6) An improved thermochromic insert for cups as in claim 5) wherein said insert is dehydrated to less than 10% humidity and preferably 6-8% humidity.

7) An improved thermochromic insert for cups as in claim 1) wherein a spindle used to form said inserts is about 1/64 inch larger than said outside wall of said inner core of said cup.

8) An improved thermochromic insert for cups as in claim 1) wherein said direct contact between the insert and the outside wall of the inner core of said cup is achieved by is forced contact between truncated cone insert and the outer wall of the inner container.

9) An improved thermochromic insert for cups as in claim 1) wherein said direct contact between the insert and the outside wall of the inner core of said cup is by adhesives on inner surface of said insert.

10) An improved thermochromic insert for cups as in claim 1) wherein said direct contact between the insert and the outside wall of the inner core of said cup is by adhesives on the outside wall of the inner core of said cup.

11) An improved thermochromic insert for cups as in claim 1) wherein said direct contact between the insert and the outside wall of the inner core of said cup is achieved by a lower extension of insert extending beyond the bottom the inner container;
said lower extension urges the truncated cone insert to maintain close contact with the outer wall of the inner container by transferring pressure from the inside base of outer container to the outside wall of said inner core.

12) An improved thermochromic insert for cups as in claim 1) wherein said inner core is made of plastic.

13) An improved thermochromic insert for cups as in claim 1) wherein said inner core is made of stainless steel.

14) An improved thermochromic insert for cups as in claim 1) wherein said thermochromic materials become clear when cooled to near the temperature of an iced drink.

15) A method for making cups with thermo chromic inserts comprising the steps of:
urging onto outer surface of the inner core of the cup the truncated cone shaped inserts, so said truncated cone shaped insert is in direct contact with said outer surface;
which inserts have applied thermochromic materials;
placing the inner core within the outer container;
and affixing the collar of the inner container to the upper lip of the outer container by means of adhesives, sonic welding, spin welding, or threads.
